(19) United States
(12) Patent Application Publication
(10) Pub. No.: US 2008/0160329 A1
(43) Pub. Date: Jul. 3, 2008

(54) MULTILAYER COATING FOR QUASI-PHASE-MATCHING ELEMENT

(75) Inventor: Ryo Tateno, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 11/873,813

(22) Filed: Oct. 17, 2007

(30) Foreign Application Priority Data
Dec. 28, 2006 (JP) 2006-353607

(51) Int. Cl. B32B 15/01

(52) U.S. Cl. 428/472

(57) ABSTRACT

Disclosed is a multilayer coating for a quasi-phase-matching (QPM) element having a substrate made of lithium metallate. The multilayer coating comprises a first layer which is in contact with the substrate and made of an oxide of a metal constituting the metallate in the lithium metallate. Specifically, when the substrate is made of lithium tantalate (LiTaO₅), the first layer may be made of tantalum pentoxide (Ta₂O₅). When the substrate is made of lithium niobate (LiNbO₃), the first layer may be made of niobium trioxide (Nb₂O₃). The multilayer coating of the present invention can provide a high-performance quasi-phase-matching element on the basis of consideration of a relationship between the substrate and the first layer of the multilayer coating.

### BACKGROUND OF THE INVENTION

1. Field of the Invention

The present invention relates to a multilayer coating technique for a quasi-phase-matching element. The multilayer coating can be used as a wavelength conversion element, for example, of a short-wavelength semiconductor laser device or of a light-to-light conversion device for optical networking.

2. Description of the Related Art

With current technologies, it is still difficult to generate a short-wavelength laser beam directly from a semiconductor laser. Therefore, there has been employed a technique of generating a long-wavelength laser beam, and then wavelength-converting the generated beam to a second-order beam or a higher-order beam so as to obtain a short-wavelength laser beam. Such a semiconductor laser device operates, for example, with an Nd:YAG crystal used as an excitation crystal (i.e., crystal to be excited) and with a KTP (KTiOPO₄) crystal used as a nonlinear optical crystal for wavelength conversion. After passing through a lens, exciting light of 809 nm wavelength output from a semiconductor laser is focused on the excitation crystal (Nd:YAG crystal), which is a base. A fundamental harmonic of 1064 nm wavelength output from the base is confined in a resonator defined between an end face of the base and a concave face of an output mirror, which will lead to lasing. The wavelength-conversion optical crystal (KTP crystal) coated with an appropriate antireflective film is inserted into the resonator to induce a second harmonic (wavelength: 532 nm) from the fundamental harmonic (wavelength: 1064 nm).

In view of ensuring stable lasing characteristics of the above wavelength conversion element, it is necessary to satisfy the following two conditions:

(1) A reflectance “R” of the end face of the base is set at a high value (R>99.9%); and

(2) A lasing wavelength is controlled to become equal to a fundamental wavelength which provides a maximum conversion efficiency during wavelength conversion in the wavelength conversion element, so as to keep a Fresnel reflection loss in the resonator at low level, and the efficiency of feedback of the lasing wavelength is enhanced to sufficiently raise a lasing threshold.

That is, it is necessary to maximize a reflectance of the end face of the base, and minimize a reflectance of an end face of the resonator.

In this connection, there has been known a technique of forming a dielectric thin film-based multilayer coating on a surface of an optical element to control a reflectance of the surface. See, for example, JP 2003-279704A. In a quasi-phase-matching (QPM) element for use as the wavelength conversion element in the above laser resonator, it is also critical to control a surface reflectance thereof. See, for example, JP 2004-239959A.

For example, in the above semiconductor laser device for generating a green laser beam of 532 nm wavelength, lithium tantalate (LiTaO₅) or lithium niobate (LiNbO₃) is used as a substrate of the QPM element. Heretofore, in a process of forming the multilayer coating on a surface of such a substrate of the QPM element, no particular consideration has been given to a relationship with the substrate, in contrast to various considerations of the configuration of the multilayer coating itself.

### SUMMARY OF THE INVENTION

In view of the above circumstances, it is an object of the present invention to provide a high-performance quasi-phase-matching element on the basis of considerations of a relationship between a substrate and a multilayer coating in a quasi-phase-matching element, particularly a relationship between the substrate and a first layer of the multilayer coating.

In order to achieve this object, the present invention provides a multilayer coating for a quasi-phase-matching element having a substrate made of lithium metallate. The multilayer coating comprises a first layer which is in contact with the substrate and made of an oxide of a metal constituting the metallate in the lithium metallate.

Specifically, when the lithium metallate of the substrate consists of lithium tantalate (LiTaO₅) or lithium niobate (LiNbO₃), the first layer in contact with the substrate may be made of a tantalum oxide or a niobium oxide.

More specifically, when the substrate is made of lithium tantalate (LiTaO₅), the first layer may be made of tantalum pentoxide (Ta₂O₅). When the substrate is made of lithium niobate (LiNbO₃), the first layer may be made of niobium trioxide (Nb₂O₃).

In a conventional quasi-phase-matching element, a multilayer coating has been formed without particularly considering a material of a first layer in contact with a substrate. Thus, radiant heat during a coating process is likely to cause polarization reversal in the quasi-phase-matching element, resulting in destruction of the element. By contrast, in the present invention, an oxide of a metal constituting the metallate in the substrate is used as the first layer to be in contact with the substrate, to allow the first layer to be vapor-deposited at a relatively low temperature. This makes it possible to drastically reduce the risk of polarization reversal in the quasi-phase-matching element and destruction of the element, while forming the multilayer coating free of film peeling.

The multilayer coating of the present invention may be formed through various conventional processes, such as an ion beam process, an ion plating process and a sputtering process.

### BRIEF DESCRIPTION OF THE DRAWINGS

FIG. 1 is a table showing parameters of vapor deposition of each layer of a multilayer coating in a specific example.

FIG. 2 is a table showing a layer structure of the multilayer coating in the example.

FIG. 3 is a graph showing a transmittance of the multilayer coating in the example.

### DESCRIPTION OF THE EXEMPLARY EMBODIMENTS

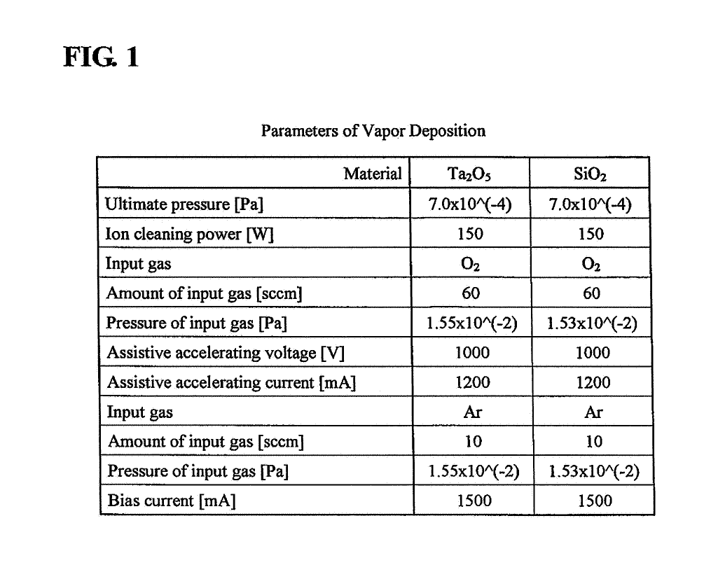

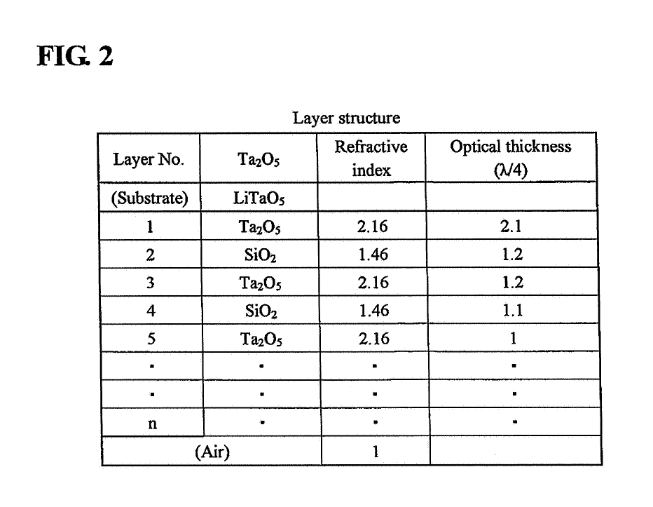

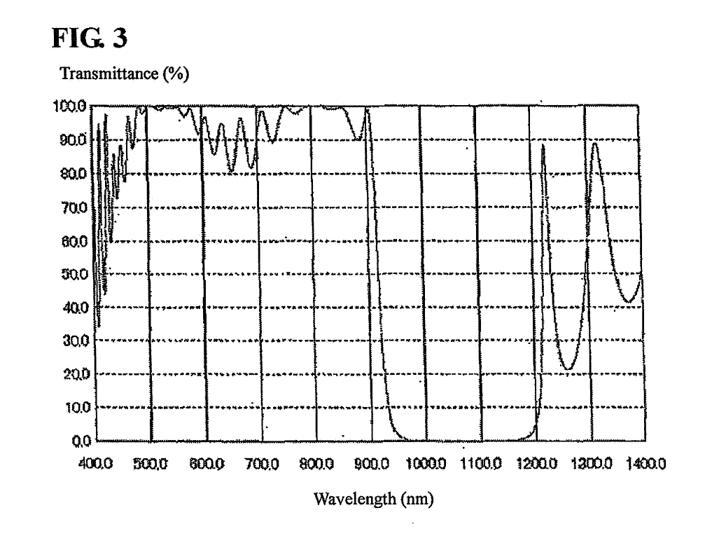

As one specific example of the present invention, a substrate made of lithium tantalate (LiTaO₅) was coated with a multilayer film comprising a tantalum pentoxide (Ta₂O₅) layer and a silicon dioxide (SiO₂) layer. In this multilayer coating, according to the spirit of the present invention, a first layer in contact with the substrate was made up of the tantalum pentoxide (Ta₂O₅) layer. Parameters of vapor deposition of each of the layers in a multilayer coating are shown in FIG. 1, and a layer structure of the entire multilayer coating is shown in FIG. 2. Further, a transmittance of the prepared multilayer coating is shown in FIG. 3 in graph form.

It was verified that the multilayer coating prepared in this manner has high durability.

What is claimed is:

1. A multilayer coating for a quasi-phase-matching element having a substrate made of lithium metallate, said multilayer coating comprising a first layer which is in contact with said substrate and made of an oxide of a metal constituting the metallate in said lithium metallate.

2. A multilayer coating for a quasi-phase-matching element having a substrate made of lithium tantalate, said multilayer coating comprising a first layer which is in contact with said substrate and made of a tantalum oxide.

3. The multilayer coating as defined in claim 2, wherein said tantalum oxide is tantalum pentoxide (Ta₂O₅).

4. A multilayer coating for a quasi-phase-matching element having a substrate made of lithium niobate, said multilayer coating comprising a first layer which is in contact with said substrate and made of a niobium oxide.

5. The multilayer coating as defined in claim 4, wherein said niobium oxide is niobium trioxide (Nb₂O₃).
